(19) United States
(12) Patent Application Publication
(10) Pub. No.: US 2024/0236281 A9
(43) Pub. Date: Jul. 11, 2024

(54) METHOD AND APPARATUS FOR GENERATING 3D IMAGE BY RECORDING DIGITAL CONTENT

(71) Applicant: AD CONNECTED, INC., Seoul (KR)

(72) Inventors: Inje CHO, Seoul (KR); Daehee LEE, Seoul (KR)

(73) Assignee: AD CONNECTED, INC., Seoul (KR)

(21) Appl. No.: 18/548,028

(22) PCT Filed: Feb. 26, 2021
(86) PCT No.: PCT/KR2021/002506

§ 371 Date: Aug. 25, 2023

(51) Int. Cl. H04N 13/106; H04N 13/383; H04N 23/60

(52) U.S. Cl. CPC H04N 13/106; H04N 13/383; H04N 23/60

(57) ABSTRACT

The present disclosure relates to a method of generating a 3D image by recording a digital content. The method includes at least: transmitting, by one or more connected devices, a captured image including the same target object or a point of interest to one device among the plurality of connected devices; receiving camera photographing condition information including at least one of a corrected location of a current device, and a location of the target object, a photographing direction, an image size, and focal length information from one device among the plurality of connected devices; generating a digital content in consideration of the received camera photographing condition information; and transmitting the generated digital content to one device among the plurality of connected devices.

### TECHNICAL FIELD

The present invention relates to a method of generating a 3D image by recording a digital content, and more particularly, to a method and an apparatus for generating a 3D image by recording a digital content, which are capable of effectively producing 360-degree 3D data by obtaining image data in various photographing directions by using multiple connected devices.

### BACKGROUND ART

In the related art, panoramic photos were taken in the left and right directions, and up and down directions and arranged in a round sphere shape, and a user stands at the camera position in the center of the sphere and views an image displayed on a wall surface of the sphere, so that distortion largely occurs.

Further, a user is fixed at the camera position and can only turn his/her head to look left, right, up, and down, so that it is difficult for the user to move the position to the camera photographing position and another position in the image and view the image.

Accordingly, there is an increasing need to reduce distortion and provide the same image as seen from the multiple photographing points by simultaneously photographing an image from cameras in multiple locations.

In the meantime, when 3D data is built by photographing a 360-degree image, the large amount of cost is consumed for collecting data. Further, when a video photographed in various photographing directions is used, it takes a long time to collect data, there is a problem in an overlapping area when a time image is stitched, and a high-resolution image of a region of interest is required. Accordingly, there is a need for a method of effectively producing 360-degree 3D data by obtaining image data in various photographing directions by multiple devices.

Prior Art 1 (KR 10-2017-0017700A) relates to an electronic device for generating a 360-degree 3D image, and is characterized in generating a left-eye spherical image and a right-eye spherical image, obtaining depth information by using the generated left/right-eye spherical image, and adjusting a three-dimensional effect by using the obtained depth information.

Prior Art 2 (KR 10-1639275B1) is characterized in that a 360-degree image is processed so as to perform up, down, left, and right zoom functions so that a user is capable of viewing a 3D spherical image generated by a 360-degree rendering processing unit as an image at a free viewpoint as desired by a user through a user interface unit, but does not disclose a particular configuration.

### DISCLOSURE

### Technical Problem

Accordingly, the first problem to be solved by the present invention is to provide a method of generating a 3D image by recording a digital content, which is capable of effectively producing 360-degree 3D data by obtaining image data in various photographing directions by using multiple connected devices.

The second problem to be solved by the present invention is to provide an apparatus for generating a 3D image by recording a digital content, which is capable of reducing distortion and providing an image as seen from multiple photographing points by photographing images from cameras at multiple locations at the same time.

Further, the present invention is to provide a computer-readable recording medium in which a program for executing the method in a computer is recorded.

### Technical Solution

In order to solve the first problem, the present invention provides a method of generating a digital content, the method including: transmitting, by one or more connected devices, a captured image including the same target object or a point of interest to one device among the plurality of connected devices; receiving camera photographing condition information including at least one of a corrected location of a current device, and a location of the target object, a photographing direction, an image size, and focal length information from one device among the plurality of connected devices; generating a digital content in consideration of the received camera photographing condition information; and transmitting the generated digital content to one device among the plurality of connected devices, in which the corrected location of the current device is determined in consideration of a location of the target object or a location of the point of interest included in the captured image, the photographing direction is parallel to a line connecting the location of the target object and the corrected location of the current device, and the focal length is determined according to a distance between the location of the target object and the corrected location of the current device, and the one or more connected devices generate the digital content with an image size included in the photographing condition information.

According to an exemplary embodiment of the present invention, the captured image may include a marker that detects the target object, and resolution of the digital content may be determined according to the focal length.

Further, it is preferable that the digital content includes head or eye tracking information of a user.

According to another exemplary embodiment of the present invention, there is provided a method of generating a digital content, the method including: determining a current location by using a captured image of a point of interest; transmitting the current location, and camera photographing condition information including at least one of a corrected location of the one or more connected devices, a photographing direction, an image size, and a focal length to one or more connected devices among a plurality of connected devices; and receiving a digital content photographed in the same image size by using the transmitted camera photographing condition information from the one or more connected devices among a plurality of connected devices, in which the corrected location is determined based on the captured images, and the photographing direction is parallel to an extended line connecting the current location and the corrected location.

The plurality of connected devices may be divided into groups to receive digital contents having different image sizes.

A marker attached to the plurality of connected devices may be detected from the captured image, and head or eye tracking information may be received from at least one connected device among the connected devices.

According to another exemplary embodiment of the present invention, there is provided a method of generating a 3D image by a server among connected devices, the method including: transmitting image photographing event information including a travel path for storing a digital content and information about a target object to a master device; transmitting point of interest information including a 3D coordinate and color information of a point of interest to the master device; calculating a current location of the master device and corrected locations of connected devices, and transmitting the calculation result and camera photographing condition information to the master device; receiving captured images photographed by using the camera photographing condition information by the connected devices through the master device; and generating a 3D image by using the received digital content, in which a photographing direction of the captured image is parallel to an extended line connecting a location of the target object and a location of at least one of the connected devices.

The camera photographing condition information may include a focal length, an image size, the corrected locations of the connected devices, and the location of the target object, and image resolution may be determined based on information of the focal length.

Further, it is preferable to classify the received captured image into different groups according to the image size included in the camera photographing condition information and generate a 3D image.

In the meantime, for the captured image having the same image size as the image size included in the camera photographing condition information, a fitting plane may be determined between the captured images so that a change in coordinate information of a point of interest existing in an overlapping area is minimized.

Further, the method may further include determining a virtual camera location connecting the captured images.

In order to solve the second problem, the present invention provides a connected device for generating a digital content, the connected device including: a transmission unit configured to transmit a captured image including the same target object or point of interest to one device among a plurality of connected devices in at least one or more connected devices; a reception unit configured to receive camera photographing condition information including at least one or more of a corrected location of a current device, and a location of the target object, a photographing direction, a focal length, and an image size from one device among the plurality of connected devices; and a photographing unit configured to generate a digital content in consideration of the received camera photographing condition information, in which the transmission unit transmits the generated digital content to one device among the plurality of connected devices, the current corrected location is determined in consideration of the location of the target object or the location of the point of interest included in the captured image, the photographing direction is parallel to a line connecting the location of the target object and the current corrected location, and the focal length is determined according to a distance between the location of the target object and the corrected current location.

According to an exemplary embodiment of the present invention, there is provided a master device for generating a digital content, the master device including: a calculation unit configured to determine a current location by using a captured image of a point of interest; a transmission unit configured to transmit the current location and camera photographing condition information including at least one or more of a corrected location of the one or more connected devices, a photographing direction, a focal length, and an image size to one or more connected devices among the plurality of connected devices; a reception unit configured to receive a digital content generated by using the camera photographing condition information from at least one connected device among the plurality of connected devices, and in which the current location is determined by comparing a boundary line or a color between the point of interest information and the captured image, the photographing direction is parallel to an extended line connecting the current location and the corrected location of the one or more connected devices, and the corrected location of the one or more connected devices is determined based on the captured images.

According to another exemplary embodiment of the present invention, there is provided a server for generating a 3D image, the server including: an event information generation unit configured to generate image photographing event information including a travel path and target object information for storing a digital content; a transmission unit configured to transmit the image photographing event information to a master device, transmit point of interest information including a 3D coordinate and color information of a point of interest to the master device, calculate a current location of the master devices and corrected locations of connected devices, and transmit the calculation result and camera photographing condition information; a reception unit configured to receive captured images generated by using the camera photographing condition information by the connected devices through the master device; and a 3D image generation unit configured to group the received digital content for each digital content and generate a 3D image by using image size information included in the photographing information, in which a photographing direction of the captured image is parallel to an extended line connecting a location of the target object and a location of at least one of the connected devices.

In order to solve another technical object, the present invention provides a computer-readable recording medium in which a program for executing the method of generating the 3D image by recording the digital content in a computer is recorded.

### Advantageous Effects

According to the present invention, it is possible to effectively product 360-degree 3D data by obtaining image data in various photographing directions by using multiple connected devices.

Further, according to the present invention, it is possible to reduce distortion and provide an image as seen from multiple photographing points by photographing an image with cameras at multiple locations at the same time.

### DESCRIPTION OF DRAWINGS

FIG. 1 is an example of photographing an image by a vehicle that is a master device and a plurality of mobile slave devices according to an exemplary embodiment of the present invention.

FIG. 2 is a diagram illustrating an apparatus for generating a 3D image by recording a digital content according to an exemplary embodiment of the present invention.

FIG. 3 illustrates a change in a focal length and an Angle Of View (AOV) in the case where a target is photographed while maintaining the same Field Of View (FOV).

FIG. 4 illustrates an example of a color marker used for easy recognition between the connected devices.

FIG. 5 illustrates a state where a plurality of vehicle and a plurality of mobile devices are wirelessly connected for recording a digital content according to another exemplary embodiment of the present invention.

FIG. 6 illustrates an example of stitching a plurality of images for processing a photographed image to a 3D image.

FIG. 7 is a flowchart illustrating a method of recording a digital content by a slave device among connected devices according to an exemplary embodiment of the present invention.

FIG. 8 is a flowchart illustrating a method of generating a 3D image by a master device among connected devices according to an exemplary embodiment of the present invention.

FIG. 9 is a flowchart illustrating a method of generating a 3D image by a server among connected devices according to an exemplary embodiment of the present invention.

### BEST MODE

The present invention relates to a method of generating a 3D image by recording a digital content, the method including: transmitting, by one or more connected devices, a captured image including the same target object or a point of interest to one device among the plurality of connected devices; receiving camera photographing condition information including at least one of a corrected location of a current device, and a location of the target object, a photographing direction, an image size, and focal length information from one device among the plurality of connected devices; generating a digital content in consideration of the received camera photographing condition information; and transmitting the generated digital content to one device among the plurality of connected devices, in which the corrected location of the current device is determined in consideration of a location of the target object or a location of the point of interest included in the captured image, the photographing direction is parallel to a line connecting the location of the target object and the corrected location of the current device, and the focal length is determined according to a distance between the location of the target object and the corrected location of the current device, and the one or more connected devices generate the digital content with an image size included in the photographing condition information, and 360-degree 3D data may be effectively produced by acquiring image data in various photographing directions by using multiple connected devices.

### Mode for Carrying out the Invention

Prior to the description of the specific contents of the present invention, for the convenience of understanding, the outline of the solution to the problem to be solved by the present invention or the core of the technical spirit is first presented.

A plurality of connected devices may photograph the same object at the same time as image having different focal lengths. In this case, the photographed image may be effectively converted into 3D image data only when it is photographed with the same focal length and the same Field Of View (FOV). In order to extract an accurate focus coordinate, a panoramic image having overlapping areas may be synthesized by using 3D location information of a Point OF Interest (POI) present in the photographed image.

Further, for the same POI, images having different resolution may be photographed in the connected devices. When the image is photographed with the cameras having the same condition, an image photographed close to the POI has higher resolution than that of an image photographed far away. Further, as the connected device is close to the target, the camera has a small Angle Of View (AOV). Accordingly, a photographing condition of the connected device needs to be adjusted so as to satisfy the constant FOV and resolution for the same POI.

The obtained 3D location information or the photographed image is used as a coordinate of the connected device, and a more accurate localization is possible by using a road map of a precise map and 3D location information and color information of main POI information stored in a DB.

Accordingly, it is possible to calculate a location of a surrounding slave device by using current location information of the master device obtained through the localization and real-time image information received from the slave device around the master device, and a result of the calculation may be transmitted to the surrounding slave device. Further, the connected devices may be recognized through a wireless signal or a physical marker present in the device. It is possible to determine whether to photograph an image and whether to transceive a camera photographing condition information between the plurality of devices depending on the recognition of the marker.

The camera photographing condition information includes camera control for obtaining image information and information provided to a user. In this case, the information provided to the user includes Augmented Reality (AR), Virtual Reality (VR), and navigation information, and the user of the device may request additional information by effectively controlling the device or transmitting a response signal in response to the information.

In this case, the camera photographing condition information includes a camera photographing direction, a FOV, an image size, a focal length, and image resolution of the mobile slave device in which the surrounding mobile slave device is capable of photographing the image in the same direction as a viewpoint of the master device.

In this case, when the image photographing of the mobile slave device is performed by a person, the master device may receive and analyze head or eye movement information of a photographer, and then provide the mobile slave device with display information.

In order to stitch images extracted from the plurality of devices, location information of the device is required. The location information of the device is calculated by a cloud server, or a local hub device or virtual machine connected with the cloud server, or is calculated by selecting a device having sufficient available resources among the local mobile devices as a master device. A location value of the master device may be calculated by using a 3D coordinate of the image and a landmark or POI collected from the plurality of devices, edge information, or precise road map information.

Further, the master device may receive front/rear/left/right images, in which the master device is photographed as a target object, from the slave device, and calculate a location of the slave device by using network location information of location information of the plurality of devices. It is preferable that the master device location, the slave device location, and the location of a specific POI are present in the same photographing direction in the image.

Further, in order to effectively recognize the locations of the devices in the image photographed from the plurality of devices, the master device and the slave device may include physical marker information.

The image photographed in the plurality of devices may be transmitted to a server (hub device or virtual machine) through the master device, and another cloud server may generate 3D image data. In this case, the 3D image data may be produced by generating a stitch tile image for each image group having the same FOV and then re-stitching the different tile images based on a virtual camera focus.

Hereinafter, exemplary embodiments will be described in detail with reference to the accompanying drawings so that those skilled in the art can easily implement the present invention. However, the exemplary embodiments are for describing the present invention in more detail, and it will be apparent to those skilled in the art that the scope of the present invention is not limited thereto.

The configuration of the invention for clarifying the solution to the problem to be solved by the present invention will be described in detail with reference to the accompanying drawings based on the exemplary embodiment of the present invention, and it should be noted in advance that in assigning reference numerals to the components of the drawings, the same reference numeral is assigned to the same component even though the component is included in a different drawing, and components of other drawings may be cited if necessary when the drawing is described. In the detailed description of an operation principle of the exemplary embodiment of the present invention, when a detailed description and the various matters of a related publicly known function or constituent element are determined to unnecessarily make the subject matter of the present invention unclear, the detailed description thereof will be omitted.

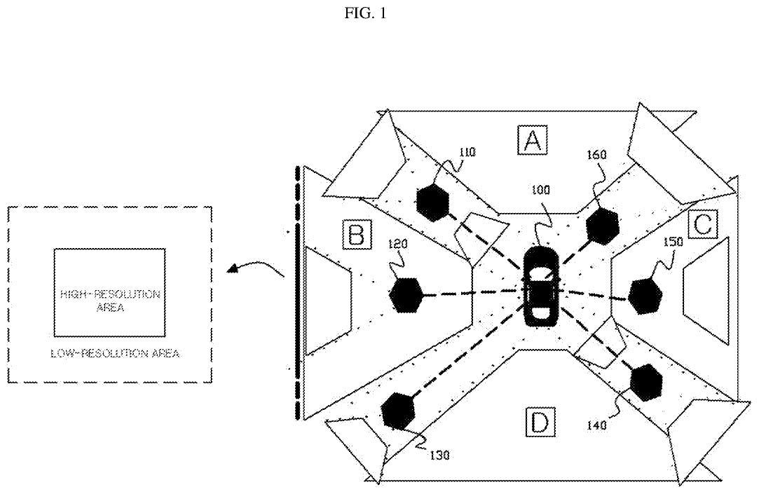

FIG. 1 is an example of photographing an image by a vehicle that is a master device and a plurality of mobile slave devices according to an exemplary embodiment of the present invention.

Referring to FIG. 1, FIG. 1 illustrates an environment in which images having multiple focuses are acquired at the same time by using a plurality of close mobile devices connected with a vehicle through a network and the corresponding images are stitched to generate 3D image information.

As an exemplary embodiment of the present invention, images having multiple focuses may be acquired from the cameras disposed at front/rear/left/right sides of the vehicle, and the mobile device may acquire images by simultaneously operating the front/rear cameras. Further, in the case where the mobile device is an automated device, such as a robot, the mobile device may be equipped with a multi-camera to acquire an automated image.

In the case of the mobile device, the user may photograph an image in accordance with a movement of the vehicle that is the predefined master device, or photograph an image by using the camera photographing condition information which the master device transmits to the mobile device of the user/After the mobile device and the master device vehicle are connected through the network, the master device vehicle may recognize the mobile device, or vice versa, the mobile device may recognize the master device vehicle.

In this case, the respective devices may be recognized in combination of the network connection and the image recognition method. For example, the devices may be connected only through the network or the image information, or the connection may be sequentially approved.

As a reference for photographing an image in the plurality of devices, it is preferable to photograph the surroundings based on the photographing direction using the master device vehicle as a target object. Accordingly, it is preferable that the master device vehicle that is the target object and the mobile device have a view of each other, or the mobile device reflects the location information of the target object in real time to photograph an image.

Further, each mobile device needs to have the same FOV and acquire an image satisfying predetermined resolution. To this end, the image satisfying the predetermined resolution may be obtained by adjusting a focal length and photographing resolution of the mobile device by using distance information between the master device vehicle and the mobile device.

Referring to FIG. 1, a vehicle 100 that is the master device and surrounding mobile devices 110, 120, 130, 140, 150, and 160 are connected through a network to acquire image information.

An image photographed in the front direction of the master device vehicle 100 is indicated as A, an image photographed in the left direction of the master device vehicle 100 is indicated as B, an image photographed in the right direction of the master device vehicle 100 is indicated as C, and an image photographed in the rear direction of the master device vehicle 100 is indicated as D.

Images A, B, C, and D are the images photographed in the master device vehicle, and have larger Angle of Views (AOV) compared to those photographed in the mobile devices 110 to 160. In the case of image B including an object located at the left side of the master device vehicle 100, resolution of the image of the mobile device 120 photographed at a close distance may be higher than resolution of the image photographed in the master device vehicle 100 and an AOV of the image of the mobile device 120 photographed at a close distance may be smaller than an AOV of the image photographed in the master device vehicle 100.

In this case, it is possible to provide an image with a wide AOV by using the image photographed in the master device vehicle 100, and in the case of zoom-in of a specific POI, it is possible to provide the image with the same resolution or high resolution by using the image photographed in the mobile device as illustrated in the right side of FIG. 1.

In this case, it is preferable that the image photographed in the plurality of mobile devices has the same image size (including the FOV and the frame size) for the image stitching and satisfies the predetermined resolution. However, the distances between the plurality of mobile devices and the master device vehicle 100 are all different, so that it is preferable to provide a 3D image satisfying a predetermined resolution by adjusting a focal length and image resolution of each mobile device in consideration of a distance difference between the mobile device and the master device vehicle 100.

The focal length and the resolution of the mobile device may be adjusted within a predetermined range by using a delta value (distance difference (i)−distance difference (j)) between the distance differences. The distance difference (i) means a distance between the mobile device i and the master device vehicle 100.

Further, when the distance difference is out of a certain range, it is preferable to exclude the image photographed in the corresponding mobile device during the 3D image stitching.

In the meantime, a method of adjusting the focal length is as follows.

$$\begin{matrix}\frac{1}{l} & \frac{1}{( )}\end{matrix} \cdot \frac{1}{f} \qquad [ Equation 1 ]$$

Herein, I is an image distance between the image and the mobile device, O is an object distance between the object and the mobile device, and f is a focal length.

In order to photograph the target with the same FOV and frame size in the plurality of mobile devices, the focal length needs to increase as the object distance O increases, and the predetermined resolution may be maintained only when the target object is photographed with high resolution (photographing with high resolution means that an image sensor has a large size). Accordingly, as the mobile device is closer to the master device vehicle 100, the object distance O from the mobile device is relatively larger, so that the focal length of the camera needs to increase, and the target object needs to be photographed with relatively high image resolution.

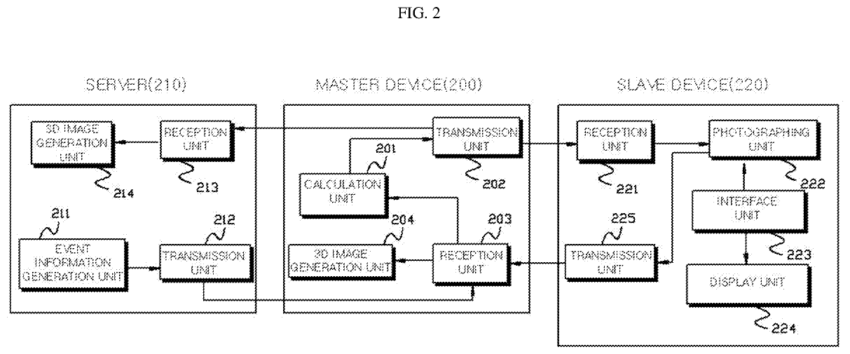

FIG. 2 is a diagram illustrating an apparatus for generating a 3D image by recording a digital content according to an exemplary embodiment of the present invention.

Referring to FIG. 2, the apparatus for generating a 3D image according to the present exemplary embodiment includes a master device 200, a server 210, and a slave device 220.

The master device 200 includes a calculation unit 201, a transmission unit 202, a reception unit 203, and a 3D image generation unit 204.

The calculation unit 201 compares POI information with captured images of the POI and determines a current location of the master device. It is preferable that the current location is determined by comparing boundary lines or colors between the POI information and the captured images. Further, the calculation unit 201 may detect a marker attached to the slave device from the captured image.

The transmission unit 202 transmits camera photographing condition information including at least one or more of the current location, a corrected location of the salve device, a photographing direction, a focal length, and an image size to at least one slave device among the plurality of connected devices.

It is preferable that the photographing direction of the slave device is parallel to a photographing direction connecting the current location and the corrected location of the slave device, and the corrected location of the slave device may be determined based on the captured images.

The reception unit 203 receives a digital content photographed by using the transmitted camera photographing condition information from at least one slave device among the connected devices.

Further, the reception unit 203 may receive head or tracking information from at least one slave device among the connected devices.

The 3D image generation unit 204 generates a 3D image by using the received digital content.

The server 210 includes an event information generation unit 211, a transmission unit 212, a reception unit 213, and a 3D image generation unit 214.

The event information generation unit 211 generates image photographing event information including a travel path for storing a digital content and target object information.

The transmission unit 212 transmits the image photographing event information to the master device, and transmits the POI information including a 3D coordinate and color information of the POI to the master device.

The transmission unit 212 may transmit a result obtained by calculating the current location of the master device and the corrected location of the connected devices, and the camera photographing condition information to the master device.

The camera photographing condition information may include at least one or more of the current location, the corrected location of the slave device, the photographing direction, the focal length, and the image size to at least one slave device among the connected devices.

It is preferable that the photographing direction of the focal length is parallel to the photographing direction connecting the corrected location and the location of the target object.

Further, it is preferable that the photographing directions of the captured images are parallel to the photographing direction connecting the location of the target object and the location of at least one of the connected devices.

The reception unit 213 receives captured images of the connected devices transmitted by the master device, and receives the image photographed by using the camera photographing condition information in the connected device.

The 3D image generation unit 214 generates a 3D image by using the received digital content. In the case of generating a real-time 3D image, the master device 200 may generate a real-time 3D image by using the digital content and 3D information of the POI received from the plurality of connected devices.

It is preferable to determine a fitting plane between the captured images having overlapped areas, and generate a 3D image so as to have the same frame size based on the POI information.

The slave device 220 includes a reception unit 221, a photographing unit 222, an interface unit 223, a display unit 224, and a transmission unit 225.

The reception unit 221 receives the camera photographing condition information including at least one or more of the current corrected location of the slave device, and the location of the target object, the photographing direction, the focal length, and the image size from the master device.

The current corrected location is determined in consideration of the location of the target object or the location of the POI included in the captured image.

It is preferable that the photographing direction is parallel to a line connecting the location of the target object and the current corrected location, and the focal length is determined according to the distance between the location of the target object and the current corrected location. The resolution of the digital content may be determined according to the focal length.

The photographing unit 222 generates a digital content in consideration of the received camera photographing condition information.

It is preferable to display an interface content according to head or eye tracking information of a user, and record the digital content according to the displayed interface content.

The interface unit 223 collects response and feedback information of the user.

The display unit 224 outputs display information, such as AR/VR/3D avatar/navigation information.

The transmission unit 225 transmits the captured image including the target object or the POI to the master device. Further, the transmission unit 225 transmits the generated digital content to the master device.

The captured image may include a marker detecting the target object.

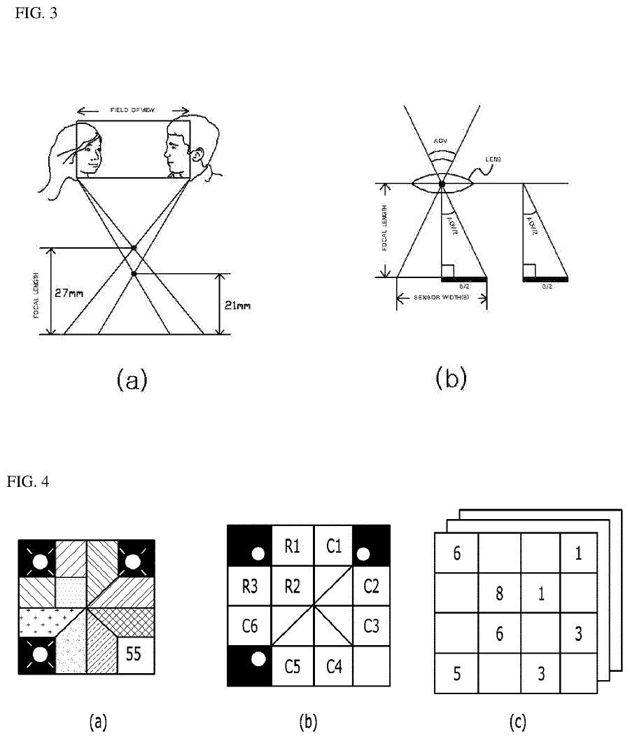

FIG. 3 illustrates a change in a focal length and an AOV in the case where a target is photographed while maintaining the same FOV.

The resolution of the image is determined by a sensor width of an image sensor, and an AOV of the image may be calculated as represented in Equation 2.

$$AOV = 2 \times arc tan ( \frac{sensor width}{2 \times focal length} ) \qquad [ Equation 2 ]$$

Referring to FIG. 3, in the case of photographing a distant target while maintaining the same FOV, the focal length needs to be longer and the target needs to be photographed with a higher resolution image. In FIG. 3, it can be seen that the image is photographed with the focal length of 27 mm and a sensor width is large.

For example, when the master device vehicle 100 is close to the mobile device, the mobile device is relatively farther away from the target to be photographed, so that the object is photographed with the long focal length and high resolution in order to maintain the same FOV. In contrast to this, when the mobile device is close to the target to be photographed, the target is photographed with the relatively shorter focal length and low resolution.

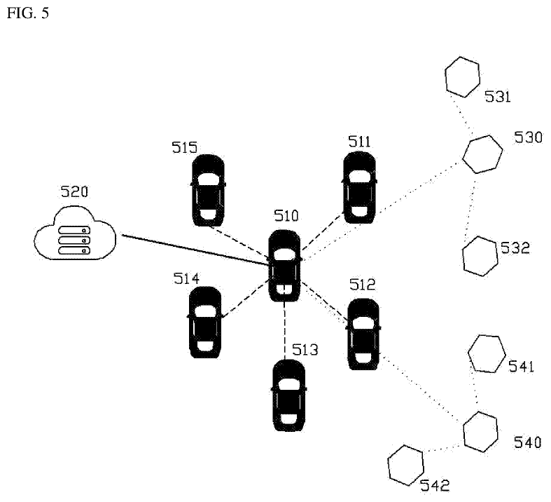

FIG. 4 illustrates an example of a color marker used for easy recognition between the connected devices.

When the plurality of images is stitched, a white balancing process for adjusting a brightness value of the image is required as the same photographing condition. It is preferable to perform the white balancing with the division of color adjustment according to brightness of the light source and color adjustment according to a temperature of the light source.

In order to perform the white balancing, the main extracted colors include red, green, blue, yellow, magenta, cyan, gray, and the like. Accordingly, in the case where a color matrix formed of the main colors used for the white balancing is formed and the corresponding color matrix is attached to the connected device, it is possible to easily recognize the connected devices to calculate the location, and determine a photographing direction with the recognized direction.

Further, the white balancing may be performed by using the color marker value recognized in the image. The principle of the white balancing performance is to compare actual R/G/B values of the main colors existing in the color marker and R/G/B values of the main colors of the marker of the photographed image and adjust the color.

Referring to FIGS. 4(a) and 4(b), basic colors R1, R2, and R3 are indicated as reference colors of the color marker, and C1 to C6 are illustrated as code colors.

The plurality of devices uses the same color marker, so that the color marker cannot be used as a unique hardware ID of the device. Accordingly, it is preferable to reconstruct the color code value of the color marker in consideration of the unique hardware ID of the device, a camera specification of the hardware, and the like.

A unique virtual color marker value may be generated by constructing multiple synthesis matrix layers in the same manner as the matrix dimension (4*4) of the color marker as illustrated in 4(c), constructing each synthesis matrix layer information in consideration of a unique hardware ID, a hardware specification, and other information of the device, and calculating a matrix product or a sum of the matrix with the color matrix value used in FIG. 4(a).

Accordingly, in the case where the camera of the device recognizes the surrounding device, the camera of the device may recognize the surrounding device with the unique hardware ID or the virtual color marker value. For example, when the color marker is recognized, the devices transceive information for calculating the location. In this case, the virtual color marker value is extracted by using the received unique hardware ID value, so that the target object or the master device vehicle 100 may be recognized by using the virtual color marker.

FIG. 5 illustrates a state where a plurality of vehicles and a plurality of mobile devices are wirelessly connected for recording a digital content according to another exemplary embodiment of the present invention.

It is preferable that a virtual machine or a hub device 520 is a server connected for performing a specific event among multiple virtual machines. The virtual machine or the hub device 520 stores and manages image photographing event information for storing a 3D digital content, and POI information including a precise map, 3D location information (3D points) related to a POI, and color information.

Further, the image photographing event information is transmitted to the vehicle master device 510. Further, the image photographing event information may be set to be transmitted to the mobile master devices 530 and 540 at the same time. For the effective network data transmission, communication is established between the vehicle master device 510 and the virtual machine 520, the vehicle master device 510 and the mobile master device 530, and the vehicle master device 510 and the mobile master device 540.

Further, the vehicle master device 510 transmits required information to the surrounding slave vehicle devices 512, 512, 513, 514, and 515, or transmits the collected information to the virtual machine 520. The mobile master devices 530 and 540 may transmit required information to the surrounding mobile slave devices 531, 532, 541, and 542, or transmit the received information to the vehicle master device 510.

In this case, it is possible to effectively generate 3D image data by recording the images at the same time by using the cameras mounted to all of the vehicles and mobile devices and transmitting the recorded images to the virtual machine 520. In this case, it is preferable that the photographing directions of the cameras mounted to all of the mobile devices are the same as the photographing direction of the camera mounted to the vehicle master device 510. Further, in order to extract the image satisfying the same FOV and the predetermined resolution, the surrounding slave vehicle devices 511, 512, 513, 514, and 515 generate images by adjusting the focal lengths for photographing a surrounding target by reflecting the distance differences with the vehicle master device 510 and adjusting the resolution according to the adjusted focal lengths.

It is preferable that the mobile master devices 530 and 540 and the surrounding mobile slave devices 531, 532, 541, and 542 also adjust focal lengths so that the image obtained from the mobile device satisfies the same FOV and the predetermined resolution by reflecting the distances from the vehicle master device 510 and adjust the resolution of the images according to the adjusted focal lengths.

The adjustment of the focal length may be calculated through the images photographed in the surrounding slave vehicle devices 511, 512, 513, 514, and 515 transmitted to the vehicle master device 510 and the location information transmitted to the vehicle master device 510. When the POI is included in the images transmitted from the surrounding slave vehicle devices 511, 512, 513, 514, and 515 to the vehicle master device 510, it may be determined that the surrounding slave vehicle devices 511, 512, 513, 514, and 515 and the vehicle master device 510 are present in the same photographing direction. Further, location information on the network of the vehicle master device 510, the surrounding slave vehicle devices 511, 512, 513, 514, and 515, and the POI may be calculated.

In this case, the vehicle master device 510 is capable of accurately calculating the locations of the surrounding slave vehicle devices 511, 512, 513, 514, and 515 by using location information of the vehicle master device 510, a precise road map stored in a DB, and 3D location information for the POI, and image color information. Accordingly, the vehicle master device 510 include the focal length, the image resolution, the location of the vehicle master device 510, the location information of the surrounding slave vehicle devices 511, 512, 513, 514, and 515, and the like into camera photographing condition information for photographing the images of the surrounding slave vehicle devices 511, 512, 513, 514, and 515 and provide the information.

As another exemplary embodiment of the present invention, the case where the plurality of vehicle master devices exists will be described.

In FIG. 5, it is assumed that the vehicle master device 510 is one, but when it is assumed that the vehicle master devices is two or more, several sub vehicle groups may be set based on each vehicle master device, and a sub vehicle group master device may be set for each sub vehicle group.

For a mobile device group, the mobile devices may be grouped as many as the number of sub mobile groups. In this case, the transception of data of the group may be effectively controlled by selecting a sub mobile group master device of each sub mobile group.

It is preferable that each sub mobile group (including a sub mobile group and a sub vehicle group) may receive the camera photographing condition information from the sub vehicle group master device or the sub mobile group master device so that the image is photographed based on the photographing direction of the sub vehicle group master device or the sub mobile group master device.

As another exemplary embodiment of the present invention, the virtual machine or the hub device 520 may transceive the camera photographing condition information with each of the sub mobile groups.

In FIG. 5, the vehicle/mobile group transceives the camera photographing condition information through the vehicle master device 510/mobile master devices 530 and 540. However, the camera photographing condition information required to all of the devices may be transceived through the virtual machine or the hub device 520 without the selection of the vehicle master device 510.

In this case, the virtual machine or the hub device 520 provides the camera photographing condition information for calculating the locations of the devices connected to the network and photographing the images of the devices.

Further, in order to produce the 3D image, the image needs to be photographed based on the photographing direction of the target object or the target device. Accordingly, the virtual machine or the hub device 520 groups the vehicle or the mobile devices based on the target object or the target device, and the image in which the photographing direction of the target object or the target device is reflected by using the location of the target object or the location of the target device and marker information for each group is provided to the virtual machine or the hub device 520. The virtual machine or the hub device 520 may calculate the locations of the vehicle or the mobile devices by using the received image and POI information.

Accordingly, the virtual machine or the hub device 520 may provide the camera photographing condition information including information of the focal length and the resolution for photographing the images of the vehicle or the mobile devices by reflecting the distances between the vehicle or the mobile devices included in the same group and the target object or the target device.

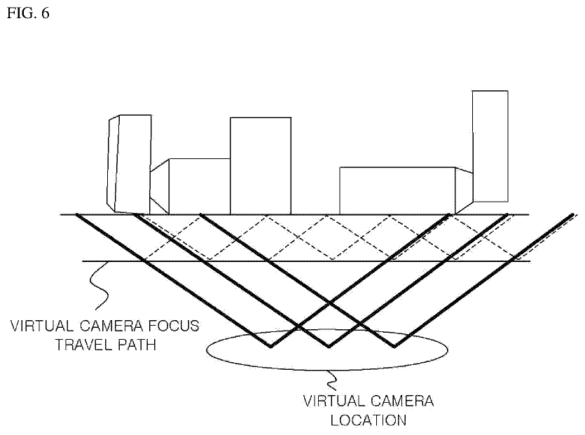

FIG. 6 illustrates an example of stitching a plurality of images for processing a photographed image to a 3D image.

Referring to FIG. 6, the images having the same FOV are classified into a group in each photographed image. The images having overlapping areas are disposed in the form of a panorama image by using a focal coordinate and a photographing direction for each classified group. A tile image is generated by stitching the disposed images.

Further, in order to stitch the tile images, a plurality of tile images may be re-stitched by using a virtual camera focus. The virtual camera focus used in this case may be a travel path of a vehicle master device 410, a target device, or a target object, or a travel path of a sub vehicle group master device, a sub mobile group master device, a sub target device, or a sub target object.

The overlapping image having the overlapping area is stitched by using the same 3D coordinate for the same POI. However, parallax occurs between the images photographed based on the plurality of focuses, so that the same POI does not exist on the same image plane in a stereo image. Accordingly, a fitting plane needs to be formed between the stereo images by using the 3D coordinate existing in the overlapping image area between the adjacent images. In this case, it is preferable to select a plane in the case where an adjustment value of the used 3D coordinate value is minimized as the fitting plane.

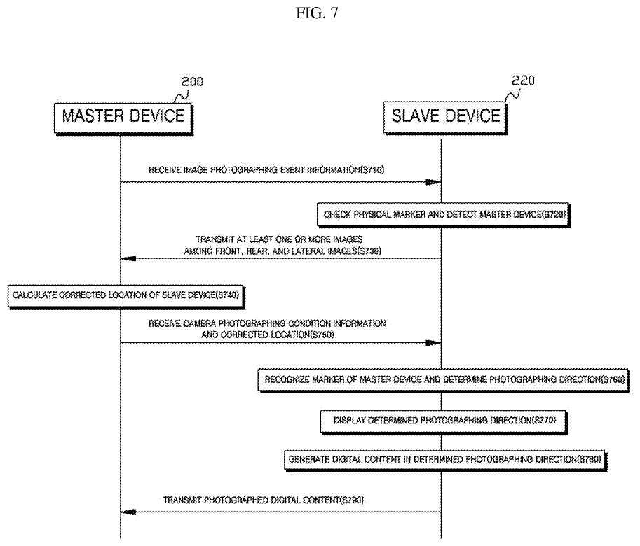

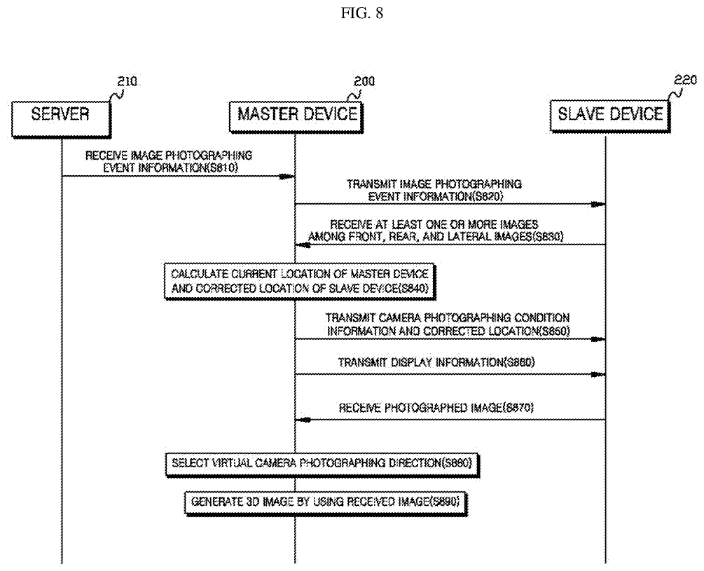

FIG. 7 is a flowchart illustrating a method of recording a digital content by a slave device among connected devices according to an exemplary embodiment of the present invention.

Referring to FIG. 7, the method of recording a digital content according to the present exemplary embodiment includes operations time-serially processed by the slave device which records the digital content illustrated in FIG. 2. Accordingly, even if omitted below, the contents described above with respect to the slave device for recording the digital content illustrated in FIG. 2 are also applied to the method of recording the digital content according to the present exemplary embodiment.

FIG. 7 illustrates a process of generating image information based on a photographing direction of a master device or a target object by the slave device among the connected devices.

In operation 710, the slave device recording the digital content receives image photographing event information from the master device 200. The image photographing event may be received from a server, such as a hub device.

For the efficient network communication, the communication is controlled based on the master device 200, and the communication with the surrounding mobile devices may be controlled by dividing the surrounding connected devices into sub groups and then selecting a sub master device of each sub group.

In operation 720, the slave device recording the digital content may check a physical marker and detects the master device. It is possible to produce a 3D image only when a view is secured between the slave device and the master device, so that in order to effectively recognize the image between the devices, it is preferable to recognize marker information existing in the device and then generate an image.

In operation 730, the slave device recording the digital content transmits front/rear/lateral images photographed by reflecting the location information of the master device to the master device.

In operation 740, the master device calculates location information of the slave device by using the front/rear/lateral images photographed by the slave device by using the location of the master device, 3D coordinate information included in the POI information stored in a DB, color information of the image, and a precise road map.

The coordinate of the slave device corrected by a triangulation method may be calculated by referring to the position of each device of the master device and the slave device. The calculation of the location of the slave device and the transmission of the camera photographing condition information for the image photographing may be performed in the master device, the sub master device, or the hub device according to the system configuration.

Further, the master device may calculate distance information between the master device and the slave device by using the calculated location coordinate of the slave device. The master device may provide the slave device with the camera photographing condition information including the focal length information and the image size required so that the slave devices generate the images having the same FOV and frame size. The image size is determined in consideration of the distance between the master device and the slave device, and the master device may divide the plurality of connected devices into digital content generating groups, and set each group to have the same image size.

The calculation of the focal length and the resolution of the photographed image of the camera photographing condition information may also be performed in the slave device. The slave device may calculate the focal length and the resolution of the photographed image by using distance information between the position of the master device and the position of the slave device and the target to be photographed.

In operation 750, the slave device recording the digital content receives corrected position information and the camera photographing condition information of the slave device from the master device or the sub master device.

In operation 760, the slave device recording the digital content determines a photographing direction by recognizing a marker attached to the master device.

Accordingly, the slave device may automatically change an effective image photographing direction angle based on the location information of the master device recognized through the marker.

In operation 770, in the case where the user determines the camera photographing direction in consideration of the location of the master device, the slave device recording the digital content may display a camera photographing direction desirable to the user on the display by using the recognized marker information of the master device.

Further, the slave device recording the digital content may acquire head/eye movement information of the user. In order to effectively collect a user's response and feedback information, the slave device may monitor head or eye movement information of the user. In order to effectively track the head and the eye, it is possible to effectively track the eye movement by measuring glint occurring due to a change in a movement of the iris of the eye by using the method of analyzing an image of a head or eye movement and a light source.

Further, the information displayed in the slave device may be AR/VR/navigation information for the effective user's recognition, and the master device or the main POI may be provided and displayed in the form of a specific 3D object and an avatar.

In operation 780, the slave device recording the digital content generates a digital content in the determined photographing direction.

In operation 790, the slave device recording the digital content transmits the photographed digital content to the master device.

In this case, referring to FIG. 5, the photographed digital content may be transmitted to the vehicle master device 510 via the mobile master devices 530 and 540. The data is transmitted to the virtual machine or the hub device 520 via the master device or the sub master device 520 according to the configuration of the system. Further, the data may be directly transmitted to the virtual machine or the hub device 520 without passing through an intermediate network node.

FIG. 8 is a flowchart illustrating a method of generating a 3D image by a master device among connected devices according to an exemplary embodiment of the present invention.

Referring to FIG. 8, the method of generating a 3D image according to the present exemplary embodiment includes operations time-serially processed in the master device generating the 3D image illustrated in FIG. 2. Accordingly, even if omitted below, the contents described above with respect to the master device generating the 3D image illustrated in FIG. 2 are also applied to the method of generating the 3D image according to the present exemplary embodiment.

In operation 810, the master device generating the 3D image receives image photographing event information from the server 210.

The received image photographing event information is re-transmitted to the surrounding slave vehicle device or the surrounding mobile slave device connected through the network. Further, the master device may receive a precise map of a surrounding road, 3D coordinate information of a main POI, color information, and POI information (reference landmark information) for the position correction from the server 210 together with the image photographing event information. In the meantime, the master device may be a vehicle or a mobile device, and the vehicle master device may be replaced with a mobile device having a communication function.

In the meantime, the master device 200 generating the 3D image is connected with the surrounding slave vehicle device or the surrounding mobile slave device through the network. In this case, all of the connected slave devices need to be capable of photographing images so that the photographing directions are the same as that of the camera of the master device 200.

The devices may be effectively recognized by recognizing marker information displayed in the master device by using an image scheme in the photographed image. Accordingly, an additional image photographing operation may be performed only on the device which is the device connected with the master device 200 through the network and recognizes the marker of the master device 200.

In operation 820, the master device generating the 3D image transmits the received image photographing event information to the slave device.

In operation 830, the master device generating the 3D image receives at least one or more images among the front, rear, and side images from the slave device.

In operation 840, the master device generating the 3D image compares the collected image information and the 3D coordinate information collected by using Lidar with the POI information (reference landmark information) and calculates a current location of the master device.

Further, the master device receives the image obtained by recognizing and photographing the vehicle master device by the slave device received in operation 830, and also calculates the location of the slave device.

It is preferable to correct the location of the slave device based on the image photographed by the master device and the image photographed by the slave device. Particularly, it is possible to recognize the plurality of slave devices and the master device through the marker, and an absolute direction angle of the slave device recognized with the marker may be determined based on the location information of the master device.

Operation 840 may be performed in the master device 200 or the server 210 according to the system configuration. When the server 210 determines the location and generates the camera photographing condition information, the master device or the slave vehicle device needs to transmit the collected image information and the Lidar information to the server 210 in real time.

In operation 850, the master device generating the 3D image transmits the corrected location information of the slave device and the camera photographing condition information. The corresponding information may be transmitted to all of the slave devices, or may be transmitted only to a specific mobile master device.

It is preferable that the master device transmits the camera photographing condition information including focal length and image resolution information, location information of each slave device, and location information of the master device to each slave device so that the slave devices photographs the images having the same FOV and frame size.

The focal length and image resolution information of the camera photographing condition information may also be calculated in the slave device by using the location information of the master device and the slave device, and the focal length information is the information determined according to a distance difference between the master device and the slave device.

As the distance difference is smaller, the distance from the target to be photographed relatively increases and the focal length increases, so that it is necessary to generate a high-resolution image. In the opposite case, as the distance difference increases, the distance between the target to be photographed and the slave device relatively decreases, so that it is effective to generate a low-resolution image having a short focal length.

In operation 860, the master device generating the 3D image transmits display information to the slave device. The master device may transmit various display information in order to collect the location of the slave device and the response and the feedback information of the user of the slave device. The display information may include AR/VR/3D avatar/navigation information and the like. Further, the master device may selectively transmit required information to a specific slave device by collecting the response information of the user of the slave device. The master device may collect a head or eye tracking result from the slave device, and transmit additional information corresponding to the analysis result to a specific slave device.

In operation 870, the master device generating the 3D image receives image information from the slave device. Referring to FIG. 5, the information may also be directly transmitted to the virtual machine or the hub device 520 without passing through the vehicle master device 510.

In operation 880, the master device generating the 3D image sets a virtual camera photographing direction.

In operation 890, the master device generating the 3D image generates a 3D image by using the received image.

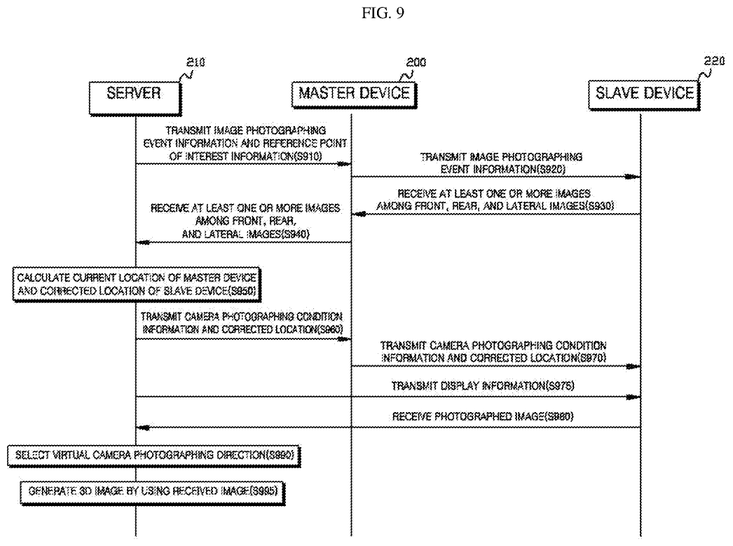

FIG. 9 is a flowchart illustrating a method of generating a 3D image by a server among connected devices according to an exemplary embodiment of the present invention.

Referring to FIG. 9, the method of generating a 3D image according to the present exemplary embodiment includes operations time-serially processed in the server generating the 3D image illustrated in FIG. 2. Accordingly, even if omitted below, the contents described above with respect to the server generating the 3D image illustrated in FIG. 2 are also applied to the method of generating the 3D image according to the present exemplary embodiment.

Referring to FIG. 9, a process of processing, by the server 210, image photographing event information and generating a 3D image is illustrated.

In operation 910, the server 210 transmits image photographing event information and POI information for acquiring an image to the master device 200. The image photographing event information may include a travel path for photographing an image.

The server 210 divides the connected devices into multiple device groups, and determines a master device in each device group. When the configured system is formed of multiple servers, a specific server may be selected as the hub device 520.

In operation 920, the master device 200 transmits the image photographing event information to the slave device 220.

In operation 930, the master device 200 receives at least one or more images among front, rear, and side images from the slave device 220.

In operation 940, the server 210 receives at least one or more images among the front, rear, and side images from the master device.

In order for the server 210 to analyze the image photographed by each device within the specific device group and effectively recognize the master device and the slave device, all of the devices may include physical marker information. The devices designated as the same group recognize the location of the master device and acquire images in the photographing direction of the master device.

In operation 950, the server 210 calculates a current location of the master device and a corrected location of the slave device. The server 210 may determine location information of all of the devices by using the received image information, and the POI information, such as the precise road map.

In operation 960, the server 210 transmits the camera photographing condition information including a focal length of an image that needs to be acquired by each device and image resolution information and the corrected position of the slave device to the master device by using the location information of the master device and the slave device.

In operation 970, the master device 200 re-transmits the received camera photographing condition information and corrected location of the slave device to the group to which the master device belongs.

In operation 975, the server 210 transmits displayed information to the specific device group including the slave devices. This is the function of analyzing the response of the user and the feedback signal, and providing the device belonging to the selected specific device group with additional display information. The display information may include AR/VR/3D avatar/navigation information and the like.

In operation 980, the server 210 may receive information about the photographed image from each slave device included in the device group to which the master device belongs without passing through the master device.

In operation 990, the server 210 selects a virtual camera photographing direction in order to stitch a tile image. In this case, the location of the master device and the location of the sub master device may be selected as the virtual camera photographing direction.

In operation 995, the server 210 re-stitches different tile image groups into one 3D image by using the selected virtual camera photographing direction. The 3D image may be created by generating a fitting plane between images having the degree of overlapping in a panoramic image. When the fitting plane is configured, image distortion occurs in the same object by parallax occurring at different focuses in the stereo image. Accordingly, an interpolation plane is determined for the object existing in the overlapping area by using the 3D coordinate.

In operation 995, the images having the same FOV and frame size need to be stitched. The time image group includes the images photographed under the similar or same condition when the image is photographed, and it is preferable that the time image group is divided into vehicle group images and mobile group images, and the stitching is performed within the same image group. Further, it is preferable to stitch the images having the same image size and generate the 3D image. The 3D image may also be generated in the master device.

According to another exemplary embodiment of the present invention, the determined location of each connected device and the camera photographing condition information are not transmitted by the master device, but may be directly transmitted to the slave device 220 by the server 210.

In this case, the server 210 requires information on the target object. The specific target object is connected through the network, and includes a physical marker. Accordingly, when the mobile device is recognizable with the physical marker information, the plurality of devices may recognize the mobile device as the target object. The plurality of devices recognizing the target object transmits the image photographed based on the target object to the server 210.

The server 210 receiving the image may calculate location values of the target object and the slave device by using the received image and the POI information, and transmit the camera photographing condition information for photographing an image to the slave device according to a distance difference between the target object and the slave device.

In this case, the camera photographing condition information includes the location of the target object, the location of the slave device, the focal length according to the distance difference between the target object and the slave device, and image resolution information.

The focal length and the image resolution may also be calculated by the slave device, not by the server 210. It is preferable that the slave device is an automated device that is capable of automatically recognizing the target object through the marker recognition and automatically determining an image AOV based on the location of the target object. When the image AOV of the slave device is determined by the user, it is necessary to provide display information for the user's effective image photographing. The display information may be selectively provided to the slave device according to a photographing state of the slave device.

Further, as the display information for effectively processing the response and the feedback signal of the user, AR/VR/3D avatar/navigation information may be provided.

In order to provide the effective display information, the slave device may track a head or eye movement of the user. The tracking information may be generated by recognizing the eye movement by analyzing the head or eye movement by using the image analysis method or detecting a change in glint according to the movement of the iris of the eye by using a light source. Additional display information may be provided based on the tracking information.

Further, the head or eye movement is provided to the server 210, and the server 210 may selectively provide the specific slave device with the effective display information by using the received head or eye movement information.

The exemplary embodiments of the present invention may be implemented in the form of a program command that can be executed through various computer means and recorded in a computer readable medium. The computer readable medium may include a program command, a data file, a data structure, and the like alone or in combination. The program command recorded in the medium may be specially designed and configured for the present invention, or may also be known and usable to those skilled in computer software. Examples of the computer readable recording medium include a magnetic medium, such as a hard disk, a floppy disk, or a magnetic tape, an optical recording medium, such as a CD-ROM or a DVD, a magneto-optical medium, such as a floptical disk, and a hardware device which is specifically configured to store and execute the program command such as a ROM, a RAM, and a flash memory. An example of the program command includes a high-level language code executable by a computer by using an interpreter, and the like, as well as a machine language code created by a compiler. The hardware device may be configured to be operated with one or more software modules in order to perform the operation of the present invention, and an opposite situation thereof is available.

The term “˜ unit” used in the present exemplary embodiment refers to software or a hardware component, such as a Field Programmable Gate Array (FPGA) or an Application Specific Integrated Circuit (ASIC), and the “˜ unit” serves a specific role. However, the “˜ unit” is not limited to software or hardware. The “˜ unit” may also be configured to be included in an addressable storage medium, and may be configured to reproduce one or more processors. Accordingly, as an example, the “˜ unit” includes components, such as software components, object-oriented software components, class components, and task components, and processes, functions, attributes, procedures, subroutines, segments of a program code, drivers, firmware, micro-codes, circuits, data, database, data structures, tables, arrays, and variables. The components and the function provided in the “˜ unit” may be combined into a smaller number of components and “˜ unit” or further separated into additional components and “˜ units”. In addition, components and the “˜ unit” may also be implemented to play one or more CPUs within a device or a security multimedia card.

All of the foregoing functions may be performed by a processor, such as a microprocessor, a controller, a micro-controller, and an ASIC, according to software or a program code coded so as to perform the function. A design, development, and implementation of the code may be obvious to those skilled in the art based on the description of the present invention.

Although the present invention has been described with reference to the exemplary embodiment of the present invention, it is understood that those skilled in the art may variously modify and change, and carry out the present invention without departing from the spirit and the scope of the present invention. Accordingly, the present invention is not limited to the foregoing exemplary embodiment, and may include all of the exemplary embodiments within the scope of the accompanying claims.

1. A method of generating a digital content, the method comprising:
transmitting, by one or more connected devices, a captured image including the same target object or a point of interest to one device among the plurality of connected devices;
receiving camera photographing condition information including at least one of a corrected location of a current device, and a location of the target object, a photographing direction, an image size, and focal length information from one device among the plurality of connected devices;
generating a digital content in consideration of the received camera photographing condition information; and
transmitting the generated digital content to one device among the plurality of connected devices,
wherein the corrected location of the current device is determined in consideration of a location of the target object or a location of the point of interest included in the captured image,
the photographing direction is parallel to a line connecting the location of the target object and the corrected location of the current device, and the focal length is determined according to a distance between the location of the target object and the corrected location of the current device, and
the one or more connected devices generate the digital content with an image size included in the photographing condition information.

2. The method of claim 1, wherein the captured image includes a marker that detects the target object.

3. The method of claim 1, wherein resolution of the digital content is determined according to the focal length.

4. The method of claim 1, wherein the digital content includes head or eye tracking information of a user.

5. A method of generating a digital content, the method comprising:
determining a current location by using a captured image of a point of interest;
transmitting the current location, and camera photographing condition information including at least one of a corrected location of the one or more connected devices, a photographing direction, an image size, and a focal length to one or more connected devices among a plurality of connected devices; and
receiving a digital content photographed in the same image size by using the transmitted camera photographing condition information from the one or more connected devices among a plurality of connected devices,
wherein the corrected location is determined based on the captured images, and
the photographing direction is parallel to an extended line connecting the current location and the corrected location.

6. The method of claim 5, wherein the plurality of connected devices is divided into groups to receive digital contents having different image sizes.

7. The method of claim 5, further comprising:
detecting a marker attached to the plurality of connected devices from the captured image.

8. The method of claim 5, further comprising:
receiving head or eye tracking information from at least one connected device among the connected devices.

9. A method of generating a 3D image of a content server, the method comprising:
transmitting image photographing event information including a travel path for storing a digital content and information about a target object to a master device;
transmitting point of interest information including a 3D coordinate and color information of a point of interest to the master device;
calculating a current location of the master device and corrected locations of connected devices, and transmitting the calculation result and camera photographing condition information to the master device;
receiving captured images photographed by using the camera photographing condition information by the connected devices through the master device; and
generating a 3D image by using the received digital content,
wherein a photographing direction of the captured image is parallel to an extended line connecting a location of the target object and a location of at least one of the connected devices.

10. The method of claim 9, wherein the camera photographing condition information includes a focal length, an image size, the corrected locations of the connected devices, and the location of the target object, and
image resolution is determined based on information on the focal length.

11. The method of claim 9, wherein the received captured image is classified into different groups according to the image size included in the camera photographing condition information and a 3D image is generated.

12. The method of claim 9, wherein for the captured image having the same image size as the image size included in the camera photographing condition information, a fitting plane is determined between the captured images so that a change in coordinate information of a point of interest existing in an overlapping area is minimized.

13. The method of claim 9, further comprising:
determining a virtual camera location connecting the captured images.

14. A connected device for generating a digital content, the connected device comprising:
a transmission unit configured to transmit a captured image including the same target object or point of interest to one device among a plurality of connected devices in at least one or more connected devices;
a reception unit configured to receive camera photographing condition information including at least one or more of a corrected location of a current device, and a location of the target object, a photographing direction, a focal length, and an image size from one device among the plurality of connected devices; and
a photographing unit configured to generate a digital content in consideration of the received camera photographing condition information,
wherein the transmission unit transmits the generated digital content to one device among the plurality of connected devices, the current corrected location is determined in consideration of the location of the target object or the location of the point of interest included in the captured image, the photographing direction is parallel to a line connecting the location of the target object and the current corrected location, and the focal length is determined according to a distance between the location of the target object and the corrected current location.

15. A master device for generating a digital content, the master device comprising:
a calculation unit configured to determine a current location by using a captured image of a point of interest;
a transmission unit configured to transmit the current location and camera photographing condition information including at least one or more of a corrected location of the one or more connected devices, a photographing direction, a focal length, and an image size to one or more connected devices among the plurality of connected devices;
a reception unit configured to receive a digital content generated by using the camera photographing condition information from at least one connected device among the plurality of connected devices; and
the current location is determined by comparing a boundary line or a color between the point of interest information and the captured image, the photographing direction is parallel to an extended line connecting the current location and the corrected location of the one or more connected devices, and the corrected location of the one or more connected devices is determined based on the captured images.

16. A server for generating a 3D image, the server comprising:
an event information generation unit configured to generate image photographing event information including a travel path and target object information for storing a digital content;
a transmission unit configured to transmit the image photographing event information to a master device, transmit point of interest information including a 3D coordinate and color information of a point of interest to the master device, calculate a current location of the master devices and corrected locations of connected devices, and transmit the calculation result and camera photographing condition information;
a reception unit configured to receive captured images generated by using the camera photographing condition information by the connected devices through the master device; and
a 3D image generation unit configured to group the received digital content for each digital content and generate a 3D image by using image size information included in the photographing information,
wherein a photographing direction of the captured image is parallel to an extended line connecting a location of the target object and a location of at least one of the connected devices.

17. A computer-readable recording medium in which a program for executing the method of claim 1 in a computer is recorded.
